(19) United States
(12) Patent Application Publication
(10) Pub. No.: US 2019/0297017 A1
(43) Pub. Date: Sep. 26, 2019

(54) MANAGING NETWORK CONGESTION USING SEGMENT ROUTING

(71) Applicant: Cisco Technology, Inc., San Jose, CA (US)

(72) Inventors: Carlos M. Pignataro, Cary, NC (US); Prashanth Patil, San Jose, CA (US); Nagendra Kumar Nainar, Morrisville, NC (US); Robert Edgar Barton, Richmond (CA); Jerome Henry, Pittsboro, NC (US); Muthurajah Sivabalan, Kanata (CA)

(21) Appl. No.: 15/934,247

(22) Filed: Mar. 23, 2018

(51) Int. Cl. H04L 12/803; H04L 12/801; H04L 12/26; H04L 29/06

(52) U.S. Cl. CPC H04L 47/122; H04L 47/11; H04L 45/22; H04L 63/1425; H04L 63/1458; H04L 43/08

(57) ABSTRACT

In one example embodiment, a first path computation element of a first segment routing domain includes a plurality of path computation clients. The first path computation element obtains, from at least one path computation client of the plurality of path computation clients, telemetry data indicating network traffic congestion for the at least one path computation client. Based on the telemetry data, the first path computation element determines that the at least one path computation client is experiencing at least a predetermined amount of network traffic congestion. In response to determining that the at least one path computation client is experiencing at least the predetermined amount of network traffic congestion, the first path computation element sends, to a second path computation element of a second segment routing domain, an indication of the network traffic congestion for the at least one path computation client.

### TECHNICAL FIELD

The present disclosure relates to computer networking.

### BACKGROUND

A Distributed Denial of Service (DDoS) attack is one of the most prominent attacks in computer network environments. DDoS attacks are typically caused by malicious attackers triggering service denial at various layers (e.g., network layer, protocol layer, end-application layer, etc.). This can be accomplished by depleting network resources, including bandwidth and/or node resources, such as memory, central processing unit (CPU), etc. Volumetric DDoS attacks can cripple an enterprise network, a service provider, a cloud service, or a portion of networks within these domains. DDoS attacks can affect a specific host and its associated network segment, and can target a specific segment (rather than a host), such as the outgoing main link of an enterprise.

Multiple DDoS prevention techniques exist, and these techniques attempt to protect the target via remotely triggered black hole (RTBH) filtering, blocking incoming network traffic with an Access Control List (ACL), using in-band traffic scrubbers, etc. Such traditional network congestion control mechanisms rely on static, local tools. For example, Quality of Service (QoS) is often employed to control traffic types with a marking/classification (e.g., Differentiated Services Code Point (DSCP), Multiprotocol Label Switching (MPLS) Experimental Bits (EXP), etc.).

### BRIEF DESCRIPTION OF THE DRAWINGS

FIG. 1 illustrates several segment routing domains in a system configured for network congestion management, according to an example embodiment.

FIGS. 2A and 2B illustrate label stacks for respective paths through the segment routing domains shown in FIG. 1, according to an example embodiment.

FIG. 3 is a block diagram further illustrating additional functional aspects of the system of FIG. 1, according to an example embodiment.

FIG. 4 is a flowchart of method for network congestion management, according to an example embodiment.

FIG. 5 is a detailed flow diagram depicting further details of the method of FIG. 4, according to an example embodiment.

FIG. 6 is a detailed flow diagram depicting still further details of the method of FIG. 4, according to an example embodiment.

FIG. 7 is a block diagram of a path computation element configured for network congestion management, according to an example embodiment.

FIG. 8 is a flowchart of a method for network congestion management, according to an example embodiment.

### DESCRIPTION OF EXAMPLE EMBODIMENTS

### Overview

In one example embodiment, a first segment routing domain includes a plurality of path computation clients. A first path computation element of the first segment routing domain obtains, from at least one path computation client of the plurality of path computation clients, telemetry data indicating network traffic congestion for the at least one path computation client. Based on the telemetry data, the first path computation element determines that the at least one path computation client is experiencing at least a predetermined amount of network traffic congestion. In response to determining that the at least one path computation client is experiencing at least the predetermined amount of network traffic congestion, the first path computation element sends, to a second path computation element of a second segment routing domain, an indication of the network traffic congestion for the at least one path computation client.

### EXAMPLE EMBODIMENTS

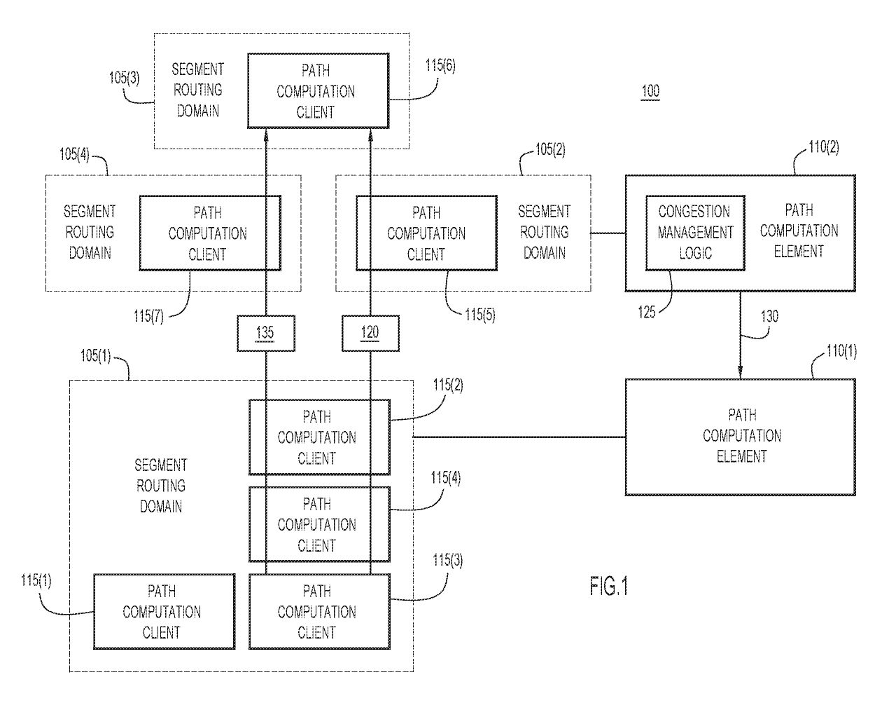

With reference made to FIG. 1, system 100 is configured for network congestion management in accordance with examples presented herein. System 100 includes segment routing domains (e.g., autonomous systems) 105(1)-105(4) and path computation elements 110(1) and 110(2). Segment routing domains 105(1)-105(4) include one or more path computation clients: segment routing domain 105(1) includes path computation clients 115(1)-115(4), segment routing domain 105(2) includes path computation client 115(5), segment routing domain 105(3) includes path computation client 115(6), and segment routing domain 105(4) includes path computation client 115(7).

Each segment routing domain 105(1)-105(4) may have an associated path computation element that is responsible for gathering topology information from the segment routing domain and making intelligent decisions for routing data packets through the segment routing domain. For example, path computation element 110(1) may handle routing decisions for data packets in segment routing domain 105(1), path computation element 110(2) may handle routing decisions for data packets in segment routing domain 105(2), etc. While not shown in FIG. 1, respective path computation elements may also handle routing decisions for data packets in segment routing domains 105(3)-105(4).

In one example, segment routing domains 105(1)-105(4) are autonomous systems that are operated by different service/cloud providers. System 100 may be a Software Defined Networking (SDN) environment, and path computation elements 110(1) and 110(2) may be SDN controllers. Path computation elements 110(1) and 110(2) may handle routing decisions using an SDN orchestration framework. Path computation clients may also be referred to herein as “network nodes” or “nodes” (e.g., path computation client 115(5) may be a node of segment routing domain 105(2)).

It will be appreciated that any number of segment routing domains (and corresponding path computation elements) may be implemented in accordance with the examples presented herein. In addition, the segment routing domains may include any number of path computation clients. For example, although segment routing domains 105(2)-105(4) are shown in FIG. 1 as including only one path computation client each (i.e., path computation clients 115(5)-115(7)), each of segment routing domains 105(2)-105(4) may include a plurality of path computation clients. Moreover, there need not necessarily be exactly one path computation element for every one segment routing domain.

Data packets are frequently routed from a source to a destination over multiple segment routing domains. For example, initially, data packet 120 is routed from segment routing domain 105(1) (i.e., path computation client 115(3), to path computation client 115(4), to path computation client 115(2)), to segment routing domain 105(2) (i.e., path computation client 115(5)), to segment routing domain 105(3) (i.e., path computation client 115(6)).

The path computation elements may construct a segment routing path comprising one or more segment identifiers (SIDs) which identify a segment in a network. Path computation element 110(1) thereby causes the data packet 120 to proceed from path computation client 115(3) to path computation client 115(4), from path computation client 115(4) to path computation client 115(2), and from path computation client 115(2) to path computation client 115(5). Similarly, path computation element 110(2) causes the data packet 120 to proceed from path computation client 115(5) to path computation client 115(6).

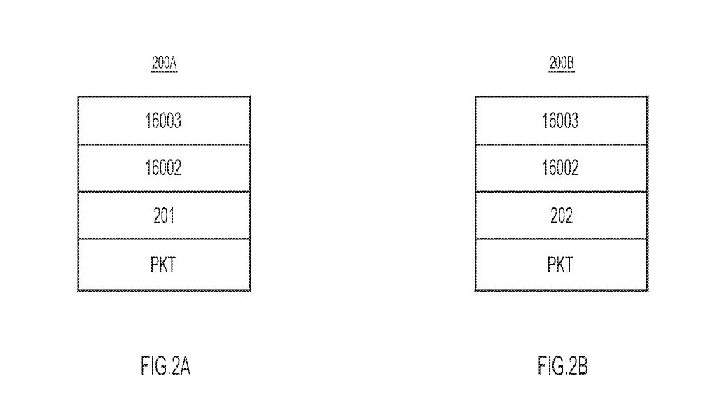

Reference is now made to FIG. 2A, with continued reference to FIG. 1. FIG. 2A illustrates a label stack 200A identifying the path taken by data packet 120 from path computation client 115(3) (segment routing domain 105(1)) to path computation client 115(5) (segment routing domain 105(2)). Label stack 200A may be inserted into the header of data packet 120. Label stack 200A includes an ordered list of SIDs, including SID 16003, SID 16002, and SID 201. In this example, SID 16003 identifies path computation client 115(4), SID 16002 identifies path computation client 115(2), and SID 201 identifies path computation client 115(5). Thus, based on the label stack 200A, path computation client 115(3) forwards the data packet 120 to path computation client 115(4) (SID 16003), path computation client 115(4) forwards the data packet 120 to path computation client 115(2) (SID 16002), and path computation client 115(2) forwards the data packet 120 to path computation client 115(5) (SID 201).

In one example, path computation element 110(2) may obtain/receive, from path computation client 115(5), telemetry data indicating network traffic congestion for path computation client 115(5). Path computation element 110(2) may obtain this telemetry data directly from the path computation client 115(5), or indirectly via one or more network congestion detection tools (e.g., Peakflow®). These network congestion detection tools may communicate directly with any network automation tools for network traffic engineering and/or network targets (e.g., firewalls, target hosts, etc.). The network congestion tools may analyze traffic patterns and identify high levels of network congestion (e.g., Transmission Control Protocol (TCP) SYN floods, Internet Control Message Protocol (ICMP) floods, User Datagram Protocol (UDP) floods, etc.).

Path computation element 110(2) may determine that path computation client 115(5) is experiencing at least a predetermined amount of network traffic congestion. In one example, the path computation element 110(2) determines that path computation client 115(5) is subject to a Distributed Denial of Service (DDoS) attack. The path computation element 110(2) may make this determination based on the telemetry data obtained from the path computation client 115(5) (e.g., based on information obtained from the network congestion detection tools). For example, the path computation element 110(2) may generate a topological heatmap of congested segments in segment routing domain 105(2). The topological heatmap may include “color-coded” nodes/links (segments) of the network to indicate the severity of network congestion (e.g., “darker” segments may indicate heavy network congestion, and “lighter” segments may indicate normal network congestion levels. The path computation element 110(2) may compare/determine DDoS attack information with a local topology database, metrics (telemetry data) learned from the path computation client 115(5) and/or one or more segment routing routers, and the topological heatmap.

Conventional DDoS mitigation techniques only address network traffic that is destined for the attacked segment. Conventionally, when network traffic is noted as potentially being part of a DDoS attack or in violation of a security policy, the traffic is re-classified as belonging to a scavenger class, or to be rate-limited or dropped. This is rudimentary and indiscriminate if, for example, there is an application-layer DDoS attack underway. Other avoidance mechanisms have a linkage to routing updates, such as using Interior Border Gateway Protocol (iBGP) to push network traffic to choke points to discard the DDoS attack packets (e.g., RTBH), or to redirect the packets to another router.

Conventional techniques merely apply mitigation mechanisms to the target (DDoS attack) traffic, and fail to mitigate the DDoS attack for network traffic that passes through the attacked segment en route to a (non-attacked) destination segment (particularly where the network traffic is transmitting across multiple segment routing domains). For example, conventional techniques would be unable to prevent data packet 120 from being routed to path computation client 115(5), even after a DDoS attack on path computation client 115(5) is detected. This is because data packet 120 originated from segment routing domain 105(1) whereas path computation client 115(5) is in segment routing domain 105(2), and because path computation client 115(5) is not the final destination segment of data packet 120. Thus, conventional techniques would allow “pass-through” network traffic (such as data packet 120) to suffer as a collateral victim of the DDoS attack on path computation client 115(5).

Accordingly, congestion management logic 125 is provided on path computation element 110(2) to resolve the forgoing issues in conventional DDoS mitigation techniques. Other path computation elements, such as path computation 110(1), may be provided/configured with similar logic. Congestion management logic 125 may enable path computation elements of adjacent segment routing domains (e.g., path computation elements 110(1) and 110(2)) to share network congestion information. This may allow each path computation element to select the optimal border router for avoiding the network congestion (e.g., DDoS attack) in the adjacent segment routing domain. Path computation elements may communicate using standard path computation element communication protocols (e.g., Path Computation Element Communication Protocol (PCEP)).

For example, in response to determining that path computation client 115(5) is experiencing at least the predetermined amount of network traffic congestion, path computation element 110(2) may send, to path computation element 110(1), an indication 130 of the network traffic congestion for path computation client 115(5). The indication 130 may include one or more of a source, a destination, a type, and a volume of network traffic that has transited path computation client 115(5). This information may relate to network traffic congestion and/or parameters indicative of an ongoing DDoS attack. The indication 130 may also include the topological heatmap and/or information to allow path computation element 110(1) to generate its own topological heatmap of segment routing domain 105(2). In response to the indication 130, path computation element 110(1) may cause network traffic in segment routing domain 105(1) to avoid path computation client 115(5).

For example, a subsequent data packet 135 may initially have the same label stack as data packet 120 (i.e., label stack 200(A)). In particular, data packet 135 may initially be destined for path computation client 115(6) via path computation client 115(5). However, upon receiving the indication 130 of the network traffic congestion for path computation client 115(5), the path computation element 110(1) may cause data packet 135 to avoid path computation client 115(5). Specifically, path computation element 110(1) may cause data packet 135 to be dynamically re-routed such that data packet 135 is routed to segment routing domain 105(3) via path computation client 115(7) (instead of via path computation client 115(5)).

Reference is now made to FIG. 2B, with continued reference to FIG. 1. FIG. 2B illustrates a label stack 200B for the path taken by data packet 135 from path computation client 115(3) (segment routing domain 105(1)) to path computation client 115(7) (segment routing domain 105(4)). The label stack 200B may include a similar ordered list as label stack 200A, with SID 202 replacing SID 201. In this example, SID 202 identifies path computation client 115(7). Thus, based on the dynamically modified label stack 200B in the packet header of the data packet 135, path computation client 115(3) forwards the data packet 120 to path computation client 115(4) (SID 16003), path computation client 115(4) forwards the data packet 120 to path computation client 115(2) (SID 16002), and path computation client 115(2) forwards the data packet 120 to path computation client 115(7) (SID 202).

Therefore, a federation of path computation elements in adjacent segment routing domains may communicate network congestion information to influence path selection. If one autonomous system is being affected by a DDoS attack, the path computation element in that autonomous system may communicate with one or more adjacent (peer) path computation elements to provide relevant information about the attack. Based on this information, the peer path computation elements may dynamically recompute alternate engineered paths through different transit networks/autonomous systems/segment routing domains (e.g., using a series of segment labels or Internet Protocol version 6 (IPv6) extension headers). These alternate engineered paths may permit pass-through traffic to be routed around DDoS congestion points and segments, thereby effectively avoiding the paralyzed portions of the network. This not only reduces the overall burden on the affected network segments, thereby weakening the DDoS attack itself, but also allows pass-through traffic (which may have otherwise transited the affected network segments) to avoid DDoS disruption.

Using centralized automation and control of traffic paths provided by segment routing, network bottlenecks caused by a sudden DDoS attack may be identified and avoided. Moreover, important DDoS attack information may be shared among automation solutions in adjacent networks. This enables networks to divert pass-through traffic around segments affected by DDoS attacks. There are many applicable use cases, including avoiding DDoS attacks on a particular data center, WAN connection, cloud service, and others.

Network congestion detection tools may relay information to a path computation element to enable network programmability to avoid DDoS congestion points. Communication between disparate segment routing domains may also help avoid the DDoS congestion points. Features of segment routing and network programmability (e.g., path computation elements) may be exploited to communicate DDoS activity within and between adjacent networks/segment routing domains. This allows for the creation of a topological heatmap at one or more path computation elements. The path computation elements may compute engineered paths around DDoS bottlenecks such that important pass-through traffic bypasses problem areas and remains unaffected.

A federation of segment routing path computation elements may communicate DDoS activity in and to adjacent networks/autonomous systems/segment routing domains. This allows one segment routing domain to warn another segment routing domain of an ongoing DDoS attack. The neighboring segment routing domain may avoid the congested segment entirely even if the neighboring segment routing domain has not yet experienced any issue with that congested segment. By contrast, conventional network congestion control mechanisms only act on the points of congestion. That is, conventionally, there is an inability to communicate network congestion information to a neighboring path computation element so as to avoid the network congestion. In addition, the path computation elements may build a DDoS heatmap of congested areas and border routers.

The path computation element may reprogram the network path using traffic engineering to avoid the problematic area. This is more effective than simple iBGP or other Interior Gateway Protocol (IGP) updates to redirect traffic when congestion occurs, because the segment routing path computation element has a topology view of the entire network/segment routing domain as well as adjacent networks/segment routing domains. The path computation element may programmatically direct traffic around DDoS activity, even when network traffic originates from segments unaffected by the congestion but may, if unchanged, will eventually reach the congested segment(s). Using a global map (e.g., topological heatmap) of the network, such traffic engineering may act at a higher level and scale than standard network congestion control mechanisms.

Path computation element 110(2) may also take action to directly mitigate the network congestion (e.g., DDoS attack) within segment routing domain 105(2). Briefly, path computation element 110(2) may leverage telemetry data (e.g., information pertaining to one or more resources, networks, flows, paths and/or performance) to differentiate regular traffic from DDoS traffic. Once detected, path computation element 110(2) may derive security policies in real-time and instantiate the policies on the appropriate path computation clients (e.g., path computation client 115(5)) to redirect/sink the traffic. This may be accomplished by leveraging tunneling mechanisms such as segment routing traffic engineering, Resource Reservation Protocol (RSVP), etc.

Path computation element 110(2) may isolate traffic and affected compute resources/services by sinking and/or steering network traffic that is deemed harmful/malicious in an automated fashion governed by security policies. Such actions have at least two purposes. First, affected services are immediately contained within the network environment and are not continually subjected to an attack. Second, once traffic has been isolated and steered to a sinkhole, the sinkhole may be subjected to further analysis and mitigation to fully counter the attack. For example, network traffic from the sinkhole may be directed to a DDoS mitigator offered by another segment routing domain or service provider. This leverages properties of segment routing to provide security bypass and sink redirection path steering and path engineering.

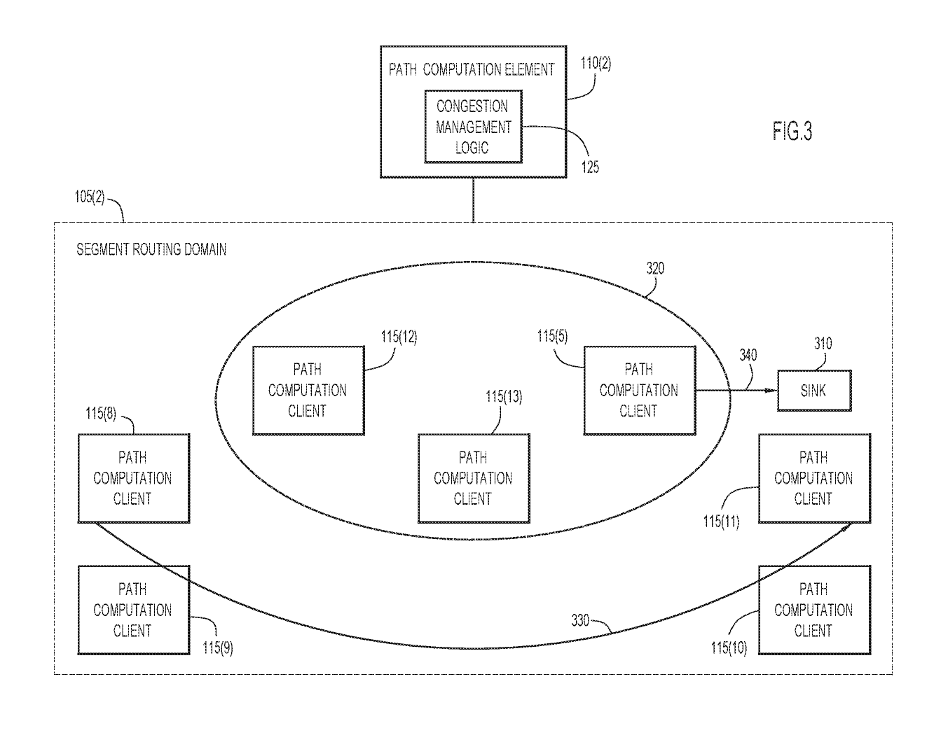

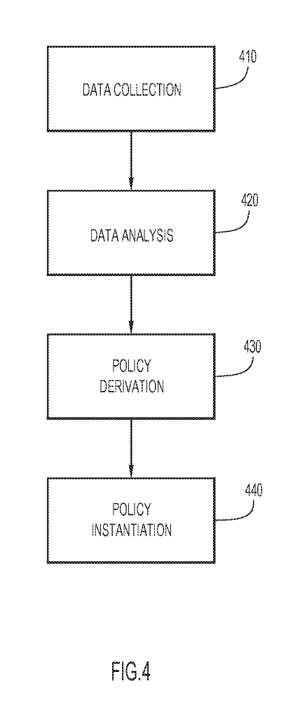

Turning now to FIG. 3, this figure illustrates further functional aspects of system 100, specifically path computation element 110(2) and segment routing domain 105(2). The example of FIG. 3 is described in reference to FIGS. 4-6, which together illustrate an example flow for network congestion management performed by path computation element 110(2). As shown in FIG. 3, segment routing domain 105(2) includes path computation clients 115(8)-115(13) in addition to path computation client 115(5). Segment routing domain 105(2) also includes a sink 310. FIG. 4 illustrates a high-level network congestion management method including data collection 410, data analysis 420, policy derivation 430, and policy instantiation 440.

Initially, at 410, the path computation element 110(2) may collect telemetry data from path computation clients 115(5) and/or 115(8)-115(13). The path computation element 110(2) may pull (request) telemetry data from path computation clients 115(5) and/or 115(8)-115(13), pull telemetry data from network flows, and/or receive telemetry data from path computation clients 115(5) and/or 115(8)-115(13) that proactively detect an anomaly.

Telemetry data may include streaming telemetry data, In-Situ Operations, Administration, and Maintenance (IOAM) telemetry data, and/or extended IOAM telemetry data. Streaming telemetry data includes data regarding node/LC level resource health information, bandwidth utilization, topology information, IGP events, etc. IOAM telemetry data includes data regarding traffic flow details, transited path, performance details along the transited path, etc. Regarding extended IOAM telemetry data, a network packet that is suspected to be malicious may include an IOAM header indicating a reason that the network packet is suspected to be malicious. The portion of the IOAM header indicating a reason that the network packet is suspected to be malicious is referred to herein as Proactive Anomaly Data (PAD).

In one example involving PAD, Control Plane Policing (CoPP) logic operating on at least path computation client 115(5) detects suspicious behavior. The suspicious behavior may include, for example, an abnormally increasing volume of drops (e.g., time-to-live (TTL) expiry, corrupted checksum, etc.). The suspicious behavior may also/alternatively include a number of packets destined for at least path computation client 115(5) (e.g., incoming ICMP packets, TCP packets, UDP packets, etc.) exceeding a threshold number of packets.

In response to detecting the suspicious behavior, at least path computation client 115(5) (which may be a transit node) may replicate and forward the suspicious packet to the path computation element 110(2). Suspicious packets may also be forwarded without replication to the path computation element 110(2). Alternatively, path computation client 115(5) may forward only relevant portions of packets (e.g., IOAM data, Network Service Header (NSH) metadata, etc.), as opposed to replicating the entire network packet.

Before forwarding the suspicious packet, path computation client 115(5) may augment the IOAM header in the replicated packet with PAD pointing to the cause for suspicion (e.g., the packet contributes to a drastically increasing drop counter, the packet exceeds a threshold percentage of packets destined for path computation client 115(5), etc.). Unlike conventional techniques in which a centralized server collects data periodically, this proactive approach with PAD may drastically reduce the time required for DDoS detection and therefore significantly improve mitigation time.

In one example, the path computation element 110(2) may send, to at least path computation client 115(5), information specifying one or more conditions that cause at least path computation client 115(5) to transmit the telemetry data. The one or more conditions may be, for example, a threshold rate of increase in a volume of drops, or a threshold percentage of packets destined for path computation client 115(5). The one or more conditions may be set by a network administrator, and/or may be learned by path computation element 110(2). In response to the occurrence of the one or more conditions, the path computation element 110(2) may receive the telemetry data (e.g., extended IOAM telemetry data).

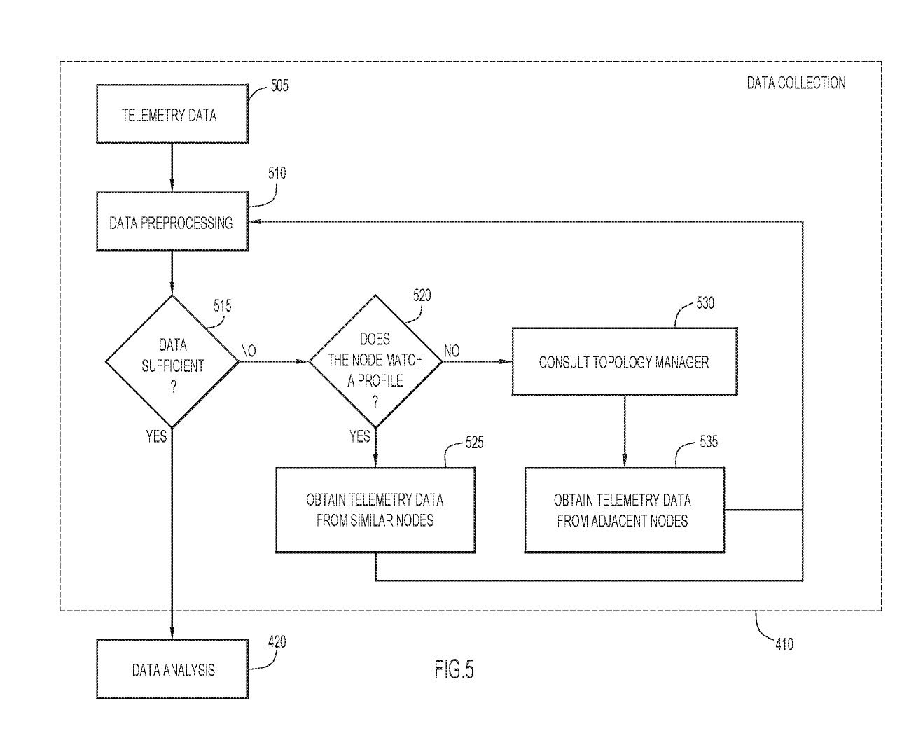

FIG. 5 illustrates a detailed operational flow of data collection 410. Initially, at 505, the path computation element 110(2) may obtain/receive the telemetry data. In one example, the telemetry data is a suspicious network packet including extended IOAM telemetry data that was forwarded by path computation client 115(5). At 510, the path computation element 110(2) may perform data preprocessing on the telemetry data. At 515, it is determined whether there is sufficient telemetry data to perform a useful analysis. This determination may be based on the clustering of data (e.g., the standard deviation of data obtained from similar or adjacent nodes) using statistics, analytics, and/or machine learning techniques. For example, if the obtained data is very similar or very different, there may be insufficient data. If there is sufficient telemetry data (“yes”), the path computation element 110(2) performs data analysis 420 on the telemetry data. If there is not sufficient telemetry data, (“no”), the path computation element 110(2) determines whether the node (e.g., path computation client 115(5)) matches a node profile at 520.

If the path computation client 115(5) matches a node profile (“yes”), at 525, the path computation element 110(2) probes (obtains telemetry data from) nodes with similar node profiles/network characteristics/signatures. These similar nodes may share one or more of a common role in the network, release, features, operational proximity, etc. In one example, a network administrator may create a profile on the segment routing domain 105(2) to generate a virtual set of all related nodes or nodes that collectively offer a common functionality.

Thus, in response to determining that path computation client 115(5) is experiencing at least a predetermined amount of network traffic congestion, the path computation element 110(2) may request, from a path computation client that shares one or more network characteristics with path computation client 115(5) (e.g., path computation client 115(8)), telemetry data indicating network traffic congestion for, e.g., path computation client 115(8). At 510, the path computation element 110(2) may preprocess the telemetry data for path computation client 115(8), and, if it is determined that there is now sufficient data at 515, the path computation element 110(2) may proceed to data analysis 420.

If the path computation client 115(5) does not match a node profile (“no”), at 530 the path computation element 110(2) consults its topology manager to obtain the topology of segment routing domain 105(2). In one example, the path computation element 110(2) generates (e.g., using the topology manager) a topology of segment routing domain 105(2). At 535, the path computation element 110(2) probes (obtains telemetry data from) nodes that are adjacent (or in topological proximity to) path computation client 115(5).

Thus, in response to determining that path computation client 115(5) is experiencing at least a predetermined amount of network traffic congestion, the path computation element 110(2) may request, from a path computation client that is topologically adjacent to path computation client 115(5) (e.g., path computation client 115(12)), telemetry data indicating network traffic congestion for, e.g., path computation client 115(12). At 510, the path computation element 110(2) may preprocess the telemetry data for path computation client 115(12), and, if it is determined that there is now sufficient data at 515, the path computation element 110(2) may proceed to data analysis 420.

Data collection 410 may involve bucketizing probes from adjacent nodes and/or similar nodes such that anomaly patterns are quickly detected. The path computation element 110(2) may perform data collection 410 because path computation element 110(2) is aware of the network topology and node profiles. In addition, the PAD obtained from a node helps accelerate early detection by enabling the path computation element 110(2) to probe proximal/similar nodes for, e.g., physical or topological location, connectivity, characteristics/features, etc., in order to correlate data and identify an anomaly.

Bucketizing nodes based on network topology (adjacency-based) and/or network topology profiles (node/traffic characteristics) enables relevancy-based data collection to detect anomaly patterns. The path computation element 110(2) may not only detect the DDoS attack on a single node, but also proactively measure the proximal/similar nodes and preemptively mitigate any potential DDoS attack on the other nodes. To facilitate this proactive DDoS attack mitigation, IOAM headers may carry PAD, and may mark a packet as a potential candidate for anomaly detection.

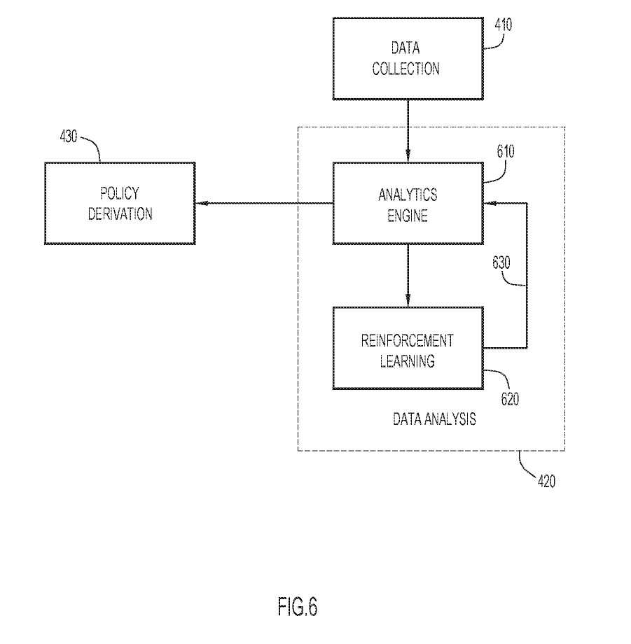

FIG. 6 illustrates a detailed operational flow of data analysis 420. At 610, the path computation element 110(2) analyzes the telemetry data (e.g., extended IOAM telemetry data) using an analytics engine. The path computation element 110(2) may perform data analysis 420 to detect/predict a DDoS attack. The collected data may be correlated with a predefined threshold to detect the DDoS attack (e.g., a threshold rate of increase in a volume of drops, a threshold percentage of packets destined for path computation client 115(5), etc.).

In a further example, the path computation element 110(2) may determine a topological heatmap (e.g., using the topology manager) of segment routing domain 105(2). Path computation element 110(2) may supplement the topological heatmap with a perimeter 320 around the nodes subject to a DDoS attack. In this example, path computation element 110(2) determines that path computation clients 115(5), 115(12), and 115(13) are subject to a DDoS attack. The path computation element 110(2) may share the topological heatmap (e.g., perimeter 320) with other path computation elements (e.g., path computation element 110(1)). The topological heatmap may also enable further data collection 410 based on the location of the DDoS attack. For example, the path computation element 110(2) may obtain further data from path computation clients 115(5), 115(12), and 115(13), and/or from proximal/similar nodes.

At 620, the path computation element 110(2) may employ a machine learning approach to predict a potential DDoS attack. The path computation element 110(2) may thereby leverage behavioral learning capabilities to create a feedback loop 630 for dynamically deriving and modifying the aforementioned thresholds. The path computation element 110(2) may provide new and/or updated thresholds to the network nodes (e.g., path computation client 115(5)). This may trigger path computation client 115(5), for example, to forward telemetry data (such as extended IOAM telemetry data) to the path computation element 110(2).

Once the data analysis 420 indicates that an anomaly has been detected, and determines relevant information regarding the anomaly (e.g., node, node set, type of traffic—QoS, flow details, etc.), the path computation element 110(2) may perform policy derivation 430 and policy instantiation 440. Briefly, the policies may utilize a path computation function to allow non-DDoS attack traffic 330 to bypass the perimeter 320, while sending DDoS attack traffic 340 to sink 310 for quarantine.

At 430, the path computation element 110(2) may derive an ingress node specific policy by leveraging the topology information (e.g., topological heatmap/perimeter 320) and extended IOAM telemetry data (e.g., PAD). The policy may include a redirect tunnel (e.g., segment routing or RSVP based traffic engineering tunnel, Generic Routing Encapsulation (GRE) tunnel, NSH/Virtual Extensible Local Area Network (VxLAN) tunnel, etc.) that causes network traffic to be redirected over a specific path to a specific Service Function (SF) (e.g., Deep Packet Inspection (DPI) function, sink 310, etc.). The policy may be instantiated on the relevant nodes (ingress node, selective SF, etc.) that will tunnel the traffic to a DPI function or sink node.

At 440, the path computation element 110(2) may instantiate the security policy (e.g., using tunnel encapsulation). The path computation element 110(2) may include security-based contextual data in the tunnel encapsulation header itself. The security-based contextual data may include the reason for DDoS determination, signature, and contextual data for the sink 310 to further evaluate the traffic within a particular security context. In one example, the path computation element 110(2) may utilize a path computation function for segment routing based on anomaly detection. This function may carve out traffic such that non-malicious traffic 330 bypasses the attack zone and malicious traffic 340 is sent to sink 310 for quarantine. Since nodes often serve multiple purposes and cater to multiple flows, the path computation function may configure multiple nodes so as to carry and propagate contextual data across all entities for appropriate traffic steering/tunnel encapsulation. The security-based contextual data may be carried in a Type-Length-Value (TLV) for SRv6, and a label advertised in IGP/SDN for segment routing MPLS. For NSH Metadata (MD) Type 2, a TLV of contextual metadata may be used.

The path computation element 110(2) may use PAD/extended IOAM telemetry data and segment routing topology to detect or predict an anomaly in a segment routing domain. For example, the path computation element 110(2) may create a snapshot of the network topology and update the same with an infected perimeter. Based on the perimeter, the path computation element 110(2) may generate a redirect tunnel/path for critical traffic to avoid the infected perimeter. This may be instantiated on ingress/border nodes to divert the non-malicious traffic. A topological graph may enable the topological identification of an infected/target area. Segment routing techniques (e.g., SRv6) may be used to bypass a topologically defined infected perimeter area (in a BGP Link State (LS), for example). The path computation element 110(2) may compute a redirect tunnel/path for infected traffic and instantiate policies on an ingress/border node to divert the traffic to sink 310. For example, malicious traffic may be automatically redirected to sink 310. The policy may also include a security posture summary within the encapsulation TLV for evaluation purposes.

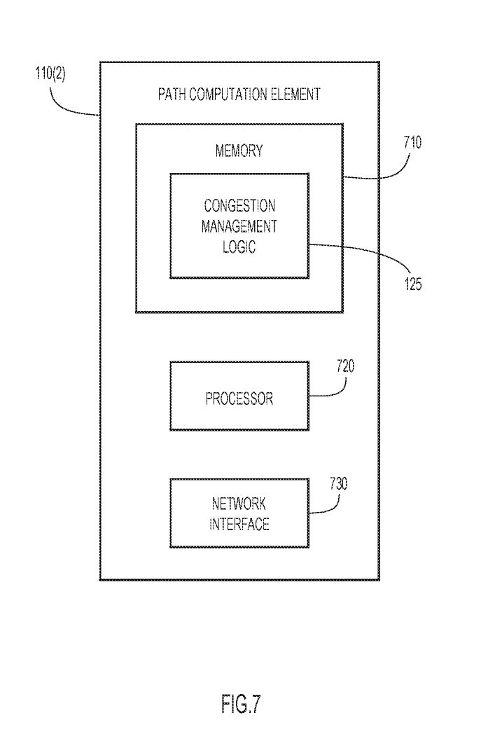

FIG. 7 is a simplified block diagram of a path computation element, such as path computation element 110(2), configured to implement the techniques presented herein. In this example, the path computation element 110(2) includes a memory 710 that stores instructions for congestion management logic 125, one or more processors 720, and a network interface 730. The one or more processors 720 are configured to execute instructions stored in the memory 710 for the congestion management logic 125. When executed by the one or more processors 720, the congestion management logic 125 causes the path computation element 110(2) to perform operations described herein. The network interface 730 is a network interface card (or multiple instances of such a device) or other network interface device that enables network communications on behalf of the path computation element 110(2) for sending and receiving messages as described above.

The memory 710 may be read only memory (ROM), random access memory (RAM), magnetic disk storage media devices, optical storage media devices, flash memory devices, electrical, optical, or other physical/tangible memory storage devices. Thus, in general, the memory 710 may be one or more tangible (non-transitory) computer readable storage media (e.g., a memory device) encoded with software comprising computer executable instructions and when the software is executed (by the processor 720) it is operable to perform the operations described herein.

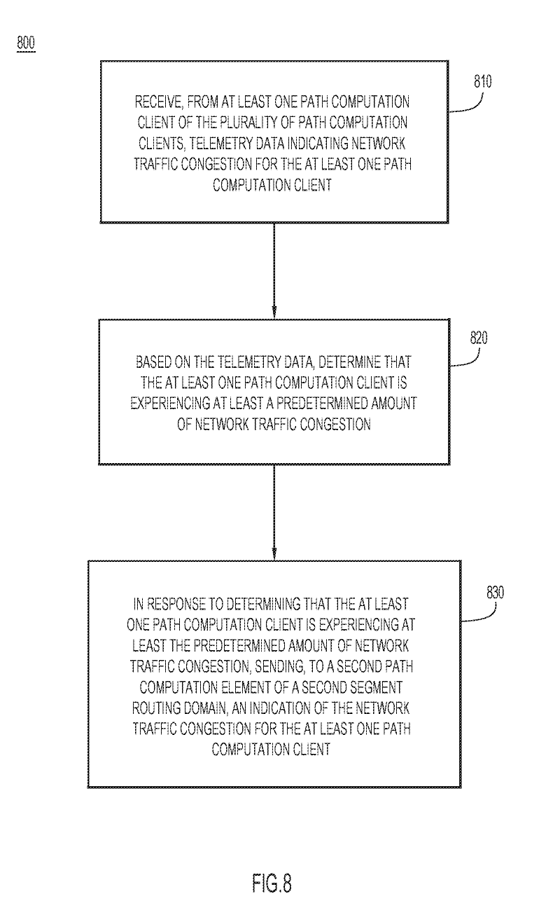

FIG. 8 is a flowchart of a method 800 for detecting (and/or mitigating) network congestion using segment routing in accordance with examples presented herein. The method 800 may be performed at a first path computation element of a first segment routing domain including a plurality of path computation clients (e.g., path computation element 110(2)). At 810, the first path computation element receives/obtains, from at least one path computation client of the plurality of path computation clients, telemetry data indicating network traffic congestion for the at least one path computation client. At 820, based on the telemetry data, the first path computation element determines that the at least one path computation client is experiencing at least a predetermined amount of network traffic congestion. At 830, in response to determining that the at least one path computation client is experiencing at least the predetermined amount of network traffic congestion, the first path computation element sends, to a second path computation element of a second segment routing domain, an indication of the network traffic congestion for the at least one path computation client.

In one form, a method is provided. The method comprises: at a first path computation element of a first segment routing domain including a plurality of path computation clients: obtaining, from at least one path computation client of the plurality of path computation clients, telemetry data indicating network traffic congestion for the at least one path computation client; based on the telemetry data, determining that the at least one path computation client is experiencing at least a predetermined amount of network traffic congestion; and in response to determining that the at least one path computation client is experiencing at least the predetermined amount of network traffic congestion, sending, to a second path computation element of a second segment routing domain, an indication of the network traffic congestion for the at least one path computation client.

In another form, a system is provided. The system comprises a first path computation element of a first segment routing domain including a plurality of path computation clients; and a second path computation element of a second segment routing domain, wherein the first path computation element is configured to: obtain, from at least one path computation client of the plurality of path computation clients, telemetry data indicating network traffic congestion for the at least one path computation client; based on the telemetry data, determine that the at least one path computation client is experiencing at least a predetermined amount of network traffic congestion; and in response to determining that the at least one path computation client is experiencing at least the predetermined amount of network traffic congestion, send, to the second path computation element of the second segment routing domain, an indication of the network traffic congestion for the at least one path computation client.

In another form, one or more non-transitory computer readable storage media are provided. The non-transitory computer readable storage media are encoded with instructions that, when executed by a processor of a first path computation element of a first segment routing domain including a plurality of path computation clients, cause the processor to: obtain, from at least one path computation client of the plurality of path computation clients, telemetry data indicating network traffic congestion for the at least one path computation client; based on the telemetry data, determine that the at least one path computation client is experiencing at least a predetermined amount of network traffic congestion; and in response to determining that the at least one path computation client is experiencing at least the predetermined amount of network traffic congestion, send, to a second path computation element of a second segment routing domain, an indication of the network traffic congestion for the at least one path computation client.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
at a first path computation element of a first segment routing domain including a plurality of path computation clients:
obtaining, from at least one path computation client of the plurality of path computation clients, telemetry data indicating network traffic congestion for the at least one path computation client;
based on the telemetry data, determining that the at least one path computation client is experiencing at least a predetermined amount of network traffic congestion; and
in response to determining that the at least one path computation client is experiencing at least the predetermined amount of network traffic congestion, sending, to a second path computation element of a second segment routing domain, an indication of the network traffic congestion for the at least one path computation client.

2. The method of claim 1, further comprising:
at the second path computation element, in response to the indication, causing network traffic in the second segment routing domain to avoid the at least one path computation client.

3. The method of claim 1, further comprising:
at the first path computation element:
sending, to the at least one path computation client, information specifying one or more conditions that cause the at least one path computation client to transmit the telemetry data, wherein
obtaining the telemetry data includes obtaining the telemetry data in response to an occurrence of the one or more conditions.

4. The method of claim 1, further comprising:
at the first path computation element, in response to determining that the at least one path computation client is experiencing at least the predetermined amount of network traffic congestion, requesting, from a path computation client of the plurality of path computation clients that shares one or more network characteristics with the at least one path computation client, telemetry data indicating network traffic congestion for the path computation client of the plurality of path computation clients that shares one or more network characteristics with the at least one path computation client.

5. The method of claim 1, further comprising:
at the first path computation element:
generating a topology of the first segment routing domain for the at least one path computation client; and
in response to determining that the at least one path computation client is experiencing at least the predetermined amount of network traffic congestion, requesting, from a path computation client of the plurality of path computation clients that is topologically adjacent to the at least one path computation client, telemetry data indicating network traffic congestion for the path computation client of the plurality of path computation clients that is topologically adjacent to the at least one path computation client.

6. The method of claim 1, wherein obtaining the telemetry data includes obtaining a network packet that is suspected to be malicious, wherein the network packet includes an In-Situ Operations, Administration, and Maintenance (IOAM) header indicating a reason that the network packet is suspected to be malicious.

7. The method of claim 1, wherein sending the indication of the network traffic congestion includes sending one or more of a source, a destination, a type, and a volume of network traffic that has transited the at least one path computation client.

8. The method of claim 1, wherein determining includes determining that the at least one path computation client is subject to a distributed denial of service attack.

9. A system comprising:
a first path computation element of a first segment routing domain including a plurality of path computation clients; and
a second path computation element of a second segment routing domain, wherein the first path computation element is configured to:
obtain, from at least one path computation client of the plurality of path computation clients, telemetry data indicating network traffic congestion for the at least one path computation client;
based on the telemetry data, determine that the at least one path computation client is experiencing at least a predetermined amount of network traffic congestion; and
in response to determining that the at least one path computation client is experiencing at least the predetermined amount of network traffic congestion, send, to the second path computation element of the second segment routing domain, an indication of the network traffic congestion for the at least one path computation client.

10. The system of claim 9, wherein the second path computation element is configured to:
in response to the indication, cause network traffic in the second segment routing domain to avoid the at least one path computation client.

11. The system of claim 9, wherein the first path computation element is further configured to:
send, to the at least one path computation client, information specifying one or more conditions that cause the at least one path computation client to transmit the telemetry data, wherein
the first path computation element is configured to obtain the telemetry data in response to an occurrence of the one or more conditions.

12. The system of claim 9, wherein the first path computation element is further configured to:
in response to determining that the at least one path computation client is experiencing at least the predetermined amount of network traffic congestion, request, from a path computation client of the plurality of path computation clients that shares one or more network characteristics with the at least one path computation client, telemetry data indicating network traffic congestion for the path computation client of the plurality of path computation clients that shares one or more network characteristics with the at least one path computation client.

13. The system of claim 9, wherein the first path computation element is further configured to:
generate a topology of the first segment routing domain for the at least one path computation client; and
in response to determining that the at least one path computation client is experiencing at least the predetermined amount of network traffic congestion, request, from a path computation client of the plurality of path computation clients that is topologically adjacent to the at least one path computation client, telemetry data indicating network traffic congestion for the path computation client of the plurality of path computation clients that is topologically adjacent to the at least one path computation client.

14. The system of claim 9, wherein the first path computation element is configured to:
obtain the telemetry data by obtaining a network packet that is suspected to be malicious, wherein the network packet includes an In-Situ Operations, Administration, and Maintenance (IOAM) header indicating a reason that the network packet is suspected to be malicious.

15. The system of claim 9, wherein the first path computation element is configured to:
send the indication of the network traffic congestion by sending one or more of a source, a destination, a type, and a volume of network traffic that has transited the at least one path computation client.

16. The system of claim 9, wherein the first path computation element is configured to:
determine by determining that the at least one path computation client is subject to a distributed denial of service attack

17. One or more non-transitory computer readable storage media encoded with instructions that, when executed by a processor of a first path computation element of a first segment routing domain including a plurality of path computation clients, cause the processor to:
obtain, from at least one path computation client of the plurality of path computation clients, telemetry data indicating network traffic congestion for the at least one path computation client;
based on the telemetry data, determine that the at least one path computation client is experiencing at least a predetermined amount of network traffic congestion; and
in response to determining that the at least one path computation client is experiencing at least the predetermined amount of network traffic congestion, send, to a second path computation element of a second segment routing domain, an indication of the network traffic congestion for the at least one path computation client.

18. The non-transitory computer readable storage media of claim 17, wherein the indication prompts the second path computation element to cause network traffic in the second segment routing domain to avoid the at least one path computation client.

19. The non-transitory computer readable storage media of claim 17, wherein the instructions further cause the processor to:
send, to the at least one path computation client, information specifying one or more conditions that cause the at least one path computation client to transmit the telemetry data, wherein
the instructions that cause the processor to obtain the telemetry data include instructions that cause the processor to obtain the telemetry data in response to an occurrence of the one or more conditions.

20. The non-transitory computer readable storage media of claim 17, wherein the instructions that cause the processor to send the indication of the network traffic congestion include instructions that cause the processor to send one or more of a source, a destination, a type, and a volume of network traffic that has transited the at least one path computation client.
